(19) United States
(12) Patent Application Publication
(10) Pub. No.: US 2016/0203425 A1
(43) Pub. Date: Jul. 14, 2016

(54) Supply Chain Risk Mitigation System

(71) Applicant: Infinera Corp., Annapolis Junction, MD (US)

(72) Inventors: Kamalesh Natvarlal Ruparel, Saratoga, CA (US); Brian D.R. Robertson, Saratoga, CA (US); Eric B. Arden, Pleasanton, CA (US); Anil Mathew, Union City, CA (US); Duc Sanh Nguyen, San Jose, CA (US)

(21) Appl. No.: 14/592,534

(22) Filed: Jan. 8, 2015

(51) Int. Cl. G06Q 10/06

(52) U.S. Cl. CPC G06Q 10/0635

(57) ABSTRACT

Systems and methods for determining a composite procurement risk rating for procuring a product part are described. Generally, parameters are registered by a host system and analyzed with at least one predetermined rule set to determine the composite procurement risk rating. An alert that includes the composite procurement risk rating may be transmitted to a user device.

### BACKGROUND

Supply chain management is an essential part of business with many businesses spending 60% or more of revenue on external purchases of goods and services. As such, sourcing and procurement can make or break a business.

Sourcing often involves locating a potential manufacturer and then evaluating, developing, and/or managing capabilities of the manufacturer in a manner consistent with the company's plans for meeting customer expectations and needs. Sourcing refers to the combined process by which the company first procures suppliers by negotiating and agreeing to terms and condition, and then managing the physical supply of goods and/or services in relation to contractually agreed upon terms and conditions.

Sourcing and procurement is critical, multi-faceted and complex in nature. Current sourcing and procurement evaluation systems within the market, however, have many issues that don't provide for the needs of the industry. For example, most sourcing reports are manually generated (e.g., excel spreadsheets), and do not provide a way to track critical parameters automatically. Sourcing and procurement of a single part, however, may be immediately affected by lead-time, geographic location of a factory, financial ratings of a manufacturer, and the like. Without immediate knowledge of these critical parameters, the company is unaware of the potential loss caused by the delay and/or unavailability of the part. For example, an earthquake in Taiwan may affect shipment of a product critical to a company's system from a Taiwanese supplier.

Thus, the present disclosure creates systems and methods that address the limitations in currently available tools by providing a procurement risk rating system that includes a full range of information that may be critical to procurement of a part, capabilities to provide automatic updates, and/or configurations to provide automatically generated alerts and/or reports upon changes in the procurement risk rating.

### SUMMARY

A method and system are disclosed. The problem of insufficient and scattered information with respect to the risk of procuring goods and/or services is addressed through methods and systems utilizing a supply chain management system in accordance with the present disclosure that dynamically gathers information indicative of the risk of procuring goods and/or services and automatically generates alerts to notify predefined personnel of changes in the risk of procuring particular goods and/or services.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of an exemplary supply chain management system in accordance with the present disclosure.

FIG. 2 is a diagrammatic view of an exemplary host system for use in the supply chain management system illustrated in FIG. 1.

FIG. 3 is a diagram illustrating multiple parameters influencing security of a supply chain.

FIGS. 4A-4C are diagrams illustrating parameters for a product part, manufacturer(s) (e.g., suppliers) and manufacturer(s) part(s) in accordance with the present disclosure.

FIG. 5 is a table illustrating an exemplary procurement risk rating system using one or more parameters illustrated in FIGS. 4A-4C in accordance with the present disclosure.

FIG. 6 is another table illustrating an exemplary procurement risk rating system using multiple parameters in accordance with the present disclosure.

FIG. 7 is an exemplary alert, generated by the host system, providing a procurement risk rating for a product part.

### DETAILED DESCRIPTION

The methods and system proposed in this disclosure circumvent the problems described above. The present disclosure describes methods and systems for supply chain risk management.

In one example, a host system having a microprocessor and a user device in communication therewith may be used to determine a composite procurement risk rating. The host system may register product part data having at least one parameter indicative of type and need of a product part for a system, manufacturer data having at least one parameter indicative of a business factor associate with at least one, and in some cases multiple manufacturers capable of providing a manufacturer part for the product part, and manufacturer part data having at least one parameter indicative of properties of the manufacturer's part. The product part data, manufacture(s) data, and manufacturer's part data may be analyzed with at least one predetermined rule set to determine a composite procurement risk rating of procuring the product part. An alert having the composite procurement risk rating may be generated and transmitted to the user device.

The composite procurement risk rating may be determined based on a single parameter or a combination of multiple parameters. For example, the composite procurement risk rating may be determined by using a single parameter that includes product part data (e.g., buffer stock available). Alternatively, the composite procurement risk rating may be determined by using parameters that include product part data (e.g., buffer stock available) and manufacturer(s) data (e.g., geographic risk). In some embodiments, the composite procurement risk rating may be further updated by updating at least one parameter, and analyzing (without user intervention) the updated parameters with the predetermined rule set to determine an updated composite procurement risk rating

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transient memory. Exemplary non-transient memory may include random access memory, read only memory, flash memory, and/or the like. Such non-transient memory may be electrically based, optically based, and/or the like.

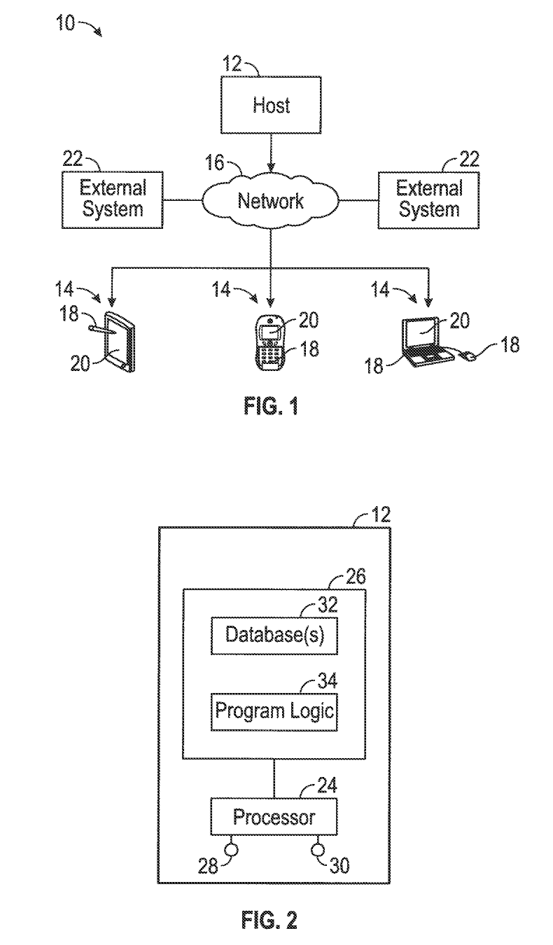

Referring now to the Figures, and in particular to FIG. 1, shown therein is a schematic diagram of hardware forming an exemplary embodiment of a supply chain risk mitigation system 10 constructed in accordance with the present disclosure. The supply chain risk mitigation system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors.

In some embodiments, the supply chain risk mitigation system 10 may be distributed, and include one or more host systems 12 communicating with one or more user devices 14 via a network 16. As used herein, the terms “network-based,” “cloud-based,” and any variations thereof, are intended to include the provision of configurable computational resources on demand via interfacing with a computer and/or computer network, with software and/or data at least partially located on the computer and/or computer network.

The supply chain risk mitigation system 10 may include the one or more host systems 12. The host system 12 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the network 16 may be the Internet and/or other network. For example, if the network 16 is the Internet, a primary user interface of the supply chain risk mitigation system 10 may be delivered through a series of web pages on private internal web pages of a company or corporation, which may be written in hypertext markup language. It should be noted that the primary user interface of the supply chain risk mitigation system 10 may be another type of interface including, but not limited to, a Windows-based application, and/or the like.

The network 16 may be almost any type of network. For example, in some embodiments, the network 16 may be an Internet and/or Internet 2 network (e.g., exist in a TCP/IP-based network). It is conceivable that in the near future, embodiments within the present disclosure may use more advanced networking technologies.

As shown in FIG. 1, the one or more user devices 14 may include, but are not limited to implementation as a personal computer, a cellular telephone, a smart phone, network-capable television set, a tablet, a laptop computer, a desktop computer, a network-capable handheld device, a server, a digital video recorder, a wearable network-capable device, and/or the like.

In some embodiments, the user device 14 may include one or more input device 18, one or more output device 20, one or more processor (not shown) capable of interfacing with the network 16, processor executable code including a web browser capable of accessing a website and/or communicating information and/or data over a network (e.g., network 16), and/or the like. As will be understood by persons of ordinary skill in the art, the user devices 14 may include one or more non-transient memory comprising processor executable code and/or software application(s), for example. Embodiments of the supply chain risk mitigation system 10 may also be modified to use any user device 14 or future developed devices capable of communicating with the host system 12 via the network 16.

The one or more input device 18 may be capable of receiving information input from a user and/or processor(s), and transmitting such information to other components of the user device 14 and/or the network 16. The one or more input devices 18 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The one or more output device 20 may be capable of outputting information in a form perceivable by a user and/or processor(s). For example, the output device 20 may include, but is not limited to, implementations as a computer monitor, a screen, a touchscreen, a speaker, a website, a television set, a smart phone, a PDA, a cell phone, a fax machine, a printer, a laptop computer, combinations thereof, and the like, for example. It is to be understood that in some exemplary embodiments, the input device 18 and the output device 20 may be implemented as a single device, such as, for example, a touchscreen or a tablet. It is to be further understood that as used herein the term user is not limited to a human being, and may comprise, a computer, a server, a website, a processor, a network interface, a human, a user terminal, a virtual computer, combinations thereof, and/or the like, for example.

In some embodiments, one or more external systems 22 may optionally communicate with the host systems 12. For example, the one or more external systems 22 may supply data transmissions regarding real-time or substantially real-time events (e.g., financial updates, weather updates, headline news). Data transmission may be through any type of communication including, but not limited to, speech, visuals, signals, textual, and/or the like. The one or more external systems 22 may supply data transmissions regarding catastrophic events such as any natural or man-made incidents that cause damage or disruption to a population, infrastructure, environment, economy, national morale, government function and/or the like, for example.

The one or more host systems 12 may interface and/or communicate with the user devices 14 and the external systems 22 via the network 16. For example, the host systems 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems directly and/or via the network 16, such as by exchanging signals (e.g., analog, digital, optical, and/or the like) via one or more ports.

The network 16 may permit bi-directional communication of information and/or data between the host system 12, the user devices 14, and/or the external systems 22. The network 16 may interface with the host system 12, the user devices 14 and/or the external systems 22 in a variety of ways. For example, in some embodiments, the network 16 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 16 may be implemented as the World Wide Web (or Internet), a local area network (LAN), a wide area network (WAN), a metropolitan network, a 4G network, a satellite network, a radio network, an optical network, a cable network, a public switch telephone network, an Ethernet network, combinations thereof, and the like, for example. Additionally, the network 16 may use a variety of network protocols to permit bi-directional interface and/or communication of data and/or information between the host system 12, the user devices 14 and/or the external systems 22.

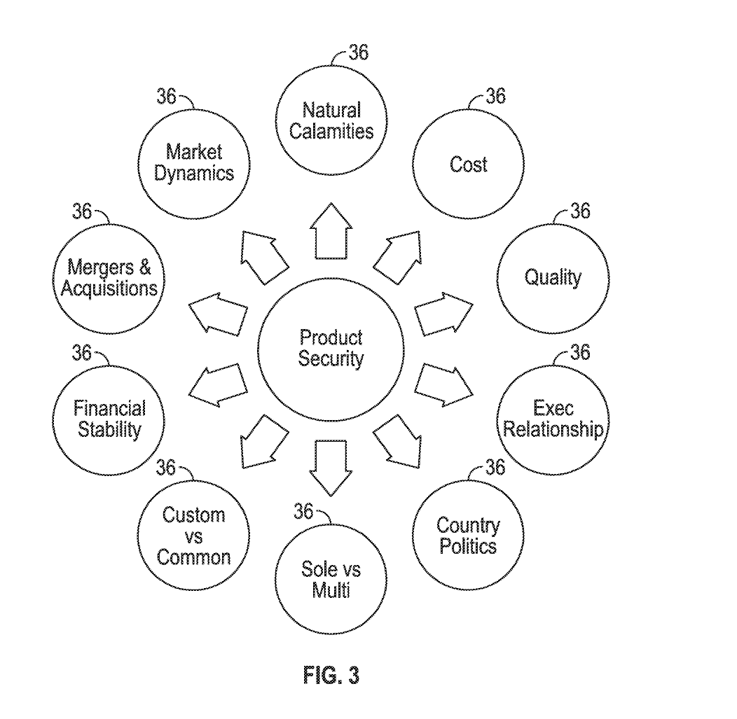

Referring to FIGS. 1 and 2, in some embodiments, the host system 12 may comprise one or more processors 24 working together, or independently to, execute processor executable code and one or more memories 26 capable of storing processor executable code. Additionally, each host system 12 may include one or more input devices 28 and one or more output devices 30. Each element of the host system 12 may be partially or completely network-based or cloud-based, and may or may not be located in a single physical location.

The processor 24 may be implemented as a single processor or multiple processors working together, or independently, to execute the logic as described herein. It is to be understood, that in certain embodiments using more than one processor 24, the processors 24 may be located remotely from one another, located in the same location, or comprise a unitary multi-core processor. The processors 24 may be capable of reading and/or executing processor executable code and/or capable of creating, manipulating, retrieving, altering, and/or storing data structures into the one or more memories 26.

Exemplary embodiments of the processor 24 may be include, but are not limited to, a digital signal processor (DSP), a central processing unit (CPU), a field programmable gate array (FPGA), a microprocessor, a multi-core processor, combinations, thereof, and/or the like, for example. The processor 24 may be capable of communicating with the one or more memories 26 via a path (e.g., data bus). The processor 24 may be capable of communicating with the input devices 28 and/or the output devices 30.

The processor 24 may be further capable of interfacing and/or communicating with the user devices 14 and/or the external systems 22 via the network 16. For example, the processor 24 may be capable of communicating via the network 16 by exchanging signals (e.g., analog, digital, optical, and/or the like) via one or more ports (e.g., physical or virtual ports) using a network protocol.

The one or more memories 26 may be capable of storing processor executable code. Additionally, the one or more memories 26 may be implemented as a conventional non-transient memory, such as for example, random access memory (RAM), CD-ROM, a hard drive, a solid state drive, a flash drive, a memory card, a DVD-ROM, a disk, an optical drive, combinations thereof, and/or the like, for example.

In some embodiments, the one or more memories 26 may be located in the same physical location as the host system 12, and/or one or more memories 26 may be located remotely from the host system 12. For example, the one or more memories 26 may be located remotely from the host system 12 and communicate with the processor 24 via the network 16. Additionally, when more than one memory 26 is used, a first memory may be located in the same physical location as the processor 24, and additional memories 26 may be located in a remote physical location from the processor 24. Additionally, one or more memories 26 may be implemented as a “cloud” memory (i.e., one or more memories 26 may be partially or completely based on or accessed using the network 16).

The one or more input devices 28 may transmit data to the processor 24 and may be similar to the input devices 18. The input devices 28 may be located in the same physical location as the processor 24, or located remotely and/or partially or completely network-based. The one or more output devices 30 may transmit information from the processor 24 to a user, and may be similar to the output devices 20. The output devices 30 may be located with the processor 24, or located remotely and/or partially or completely network-based.

The one or more memories 26 may store processor executable code and/or information comprising one or more databases 32 and program logic 34. In some embodiments, the processor executable code may be stored as a data structure, such as a database and/or data table, for example.

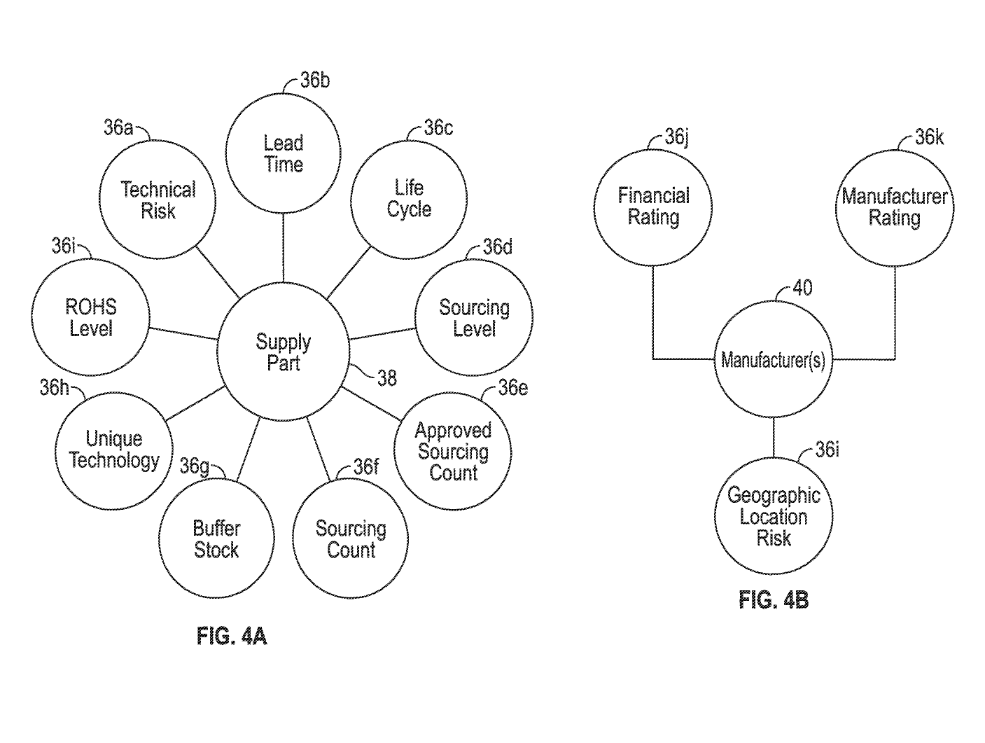

Referring now to FIG. 3, shown therein is a general diagram illustrating exemplary parameters 36 that may affect supply security. For example, sourcing strategy for one or more supplies may be affected by market dynamics, natural calamities, costs of the supply, quality of the supply and/or supplier, executive relationship with the supplier, country politics of the supplier, custom supplies vs. common supplies, financial stability of the country and/or supplier, mergers and acquisitions, whether the supply is from a sole supplier or multiple suppliers, intellectual property control, and/or the like. Generally, such parameters 36 may be analyzed to determine a risk rating (i.e., procurement risk rating) for each part as described in further detail herein. In some embodiments, interdependencies between the parameters may be analyzed to determine the risk rating.

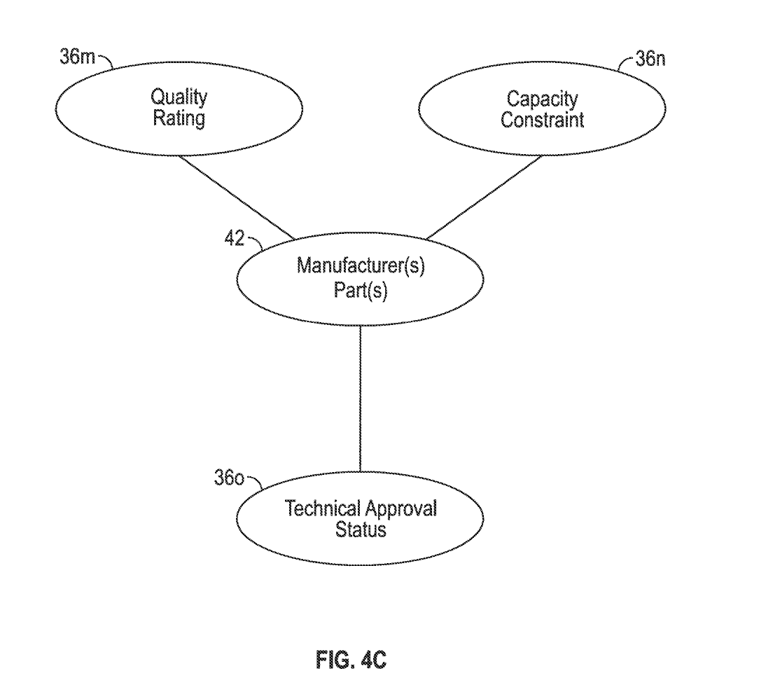

Referring to FIGS. 4A-4C, the supply chain risk mitigation system 10 may initially prompt or be provided data regarding one or more parameters 36 related to a product part 38, manufacturer(s) 40 of the product part, and manufacturer(s) part(s) 42. As illustrated in FIG. 4A, the supply chain risk mitigation system 10 may prompt or be provided parameters 36 for product part data related to the product part 38. The product part data provided may be indicative of the type and need of the product part 38. For example, such data may include, but is not limited to, technical risk 36a, lead time 36b, stage of the life cycle within the company 36c (e.g., restricted, preferred, approved), sourcing level 36d, approved sourcing counts 36e, sourcing count 36f, amount of buffer stock 36g, identification of unique technology 36h, and/or the RoHS level 36i. Additionally, other parameters may be used including, but not limited to intellectual property control, and/or the like.

Criticality of the product part 38 may be assessed using the parameters 36a-h illustrated in FIG. 4A, for example. Referring to FIGS. 1 and 4A, in some embodiments, this may be accomplished by the supply chain risk mitigation system 10 presenting a variety of questions or prompts to a user (e.g., via user device 14 illustrated in FIG. 1), and then recording the user's answers to the questions. For example, the questions or prompts may be directed to elicit information from a user regarding at least parameters 36a-36f and store such information within one or more fields within the database 32. In some embodiments, one or more documents (e.g., spreadsheets, reports) and/or data may be provided to the host system 12 of the supply chain risk mitigation system 10. The documents may include values related to one or more parameters 36a-h. The supply chain risk mitigation system 10 may analyze and determine appropriate values for each parameter 36a-36h using such documents and then store the information within one or more fields within the database 32.

Referring to FIG. 4A, product part data related to technical risk 36a of the product part 38 may include architecture changes to the system, design verification testing (DVT), any manufacturing qualifications, any paper qualifications, and/or the like. For example, review and analysis of a data sheet provided by a manufacturer may provide an appropriate value for paper qualification. In this example, specifications provided in the data sheet may be compared against needs for the product part 38 and determined to be acceptable, or not acceptable.

Product part data related to lead time 36b of the product part 38 may include the time between the initiation and completion of the part of interest. In some embodiments, a default value may be given for lead time. For example, a default value of 10-12 weeks may be provided as a default value for lead time.

The product part data related to the life cycle 36c of the product part 38 may provide two or more categories assigning the product part 38 to a specific stage. For example, the life cycle 36c may be separated into stages including, but not limited to, preliminary, design, production, deprecated, obsolete, and/or the like.

In some embodiments, product part data may also identify the sourcing level 36d of the product part 38. The sourcing level 36d may be selected as one of three options: common, custom, or sole, for example. The product part data relating to sourcing count 36e and an approved sourcing count 36f may also be identified, in addition to the amount of buffer stock 36g currently in inventory. Each of these values may be updated as needed or on a set periodic basis. Further, the product part data may include identification of the product part 38 as a unique technology 36h by identification values of YES, NO, or SEMI, for example.

Finally, the product part data may include an identification of the Restriction of Hazardous Substances (RoHS) Level 36i. The RoHS levels may identify the product part 38 as compliant, ⅚ compliant, not-compliant, or status unknown, for example.

Referring now to FIGS. 1 and 4B, the supply chain risk mitigation system 10 may also prompt or be provided manufacturer data related to parameters 36 for the manufacturer(s) 40 of the product part 38. The manufacturer data may be indicative of business factors associated with the manufacturer that may impact the manufacturer's ability to provide the product part 38 on a timely basis. Such manufacturer data may include parameters including, but not limited to, financial rating of the manufacturer 36j, manufacturer rating 36k, location risk of the geographic location of the manufacturer 36l, and/or the like. Criticality of the manufacturer(s) 40 may be assessed using such parameters 36j-1. In some embodiments, this may be accomplished by the host system 12 of the supply chain risk mitigation system 10 presenting a variety of questions or prompts to a user via the one or more user devices 14, and then recording the user's answers to the questions. For example, the questions or prompts may be directed to elicit information from a user regarding manufacturer data related to at least parameters 36j-l. In some embodiments, one or more documents and/or data may be provided to the supply chain risk mitigation system 10 for analysis and determination of the parameters 36j-l. A third party system or external system 22, as illustrated in FIG. 1, may provide data regarding one or more parameters 36j-l. For example, one or more external systems 22 may provide data relating to the financial rating of the manufacturer 36l for analysis by the supply chain risk mitigation system 10.

Manufacturer data related to the financial rating 36j of the manufacturer 40 may include an internally determined classification, an externally determined classification, or a combination of both. For example, in some embodiments, a supplier evaluation risk rating (SER) may be provided by an external source (e.g., Dun & Bradstreet). The financial rating 36j may predict a business's likelihood of ceasing operations or becoming inactive over the next twelve months based on predictive data attributes available on the business, for example. Such ratings may predict the likelihood that one of the following events may occur such as, for example, voluntarily or involuntarily going out of business, becoming dormant or inactive, filing for bankruptcy, and/or the like.

The manufacturer data may also include the manufacturer rating 36k. The manufacturer rating 36k may be an internally determined classification, an externally determined classification, or a combination of both. For example, prior experience with the manufacturer may associate the manufacturer as, preferred, approved, restricted, disqualified, strategic, pending, abandoned, and/or the like.

Further, manufacturer data related to the geographic location 36l of the manufacturer 40 may be associated with a risk level. The risk level may be based on one or more determining factors including, government stability, financial stability of the geographic location, natural calamities, and/or the like. Classification of the risk level may isolate the particular factors (e.g., government stability, natural disasters), or be provided in a general YES or NO answer on whether a risk exists for the geographic location 36l, for example.

Referring to FIGS. 1 and 4C, the supply chain risk mitigation system 10 may also prompt or be provided parameters 36 for manufacturer part data related to the manufacturer(s) part(s) 42 to be used as the product part 38 of FIG. 4A. It should be noted that in some embodiments that a sole manufacturer may provide a single manufacturer part, a sole manufacturer may provide multiple manufacturer parts, multiple manufacturers may provide for a single manufacturer part, or multiple manufacturers may provide for multiple manufacturer parts.

The manufacturer part data may be indicative of properties and characteristics of the manufacturer part 42. Such parameters may include, but are not limited to, quality rating 36m of the part 42, capacity constraint 36n of the part 42, technical approval status 36o of the part 42, and/or the like. Criticality of using the particular manufacturer part 42 may be assessed using such parameters 36m-o. In some embodiments, this may be accomplished by the host system 12 of the supply chain risk mitigation system 10 presenting a variety of questions or prompts to a user via the one or more user devices 14, and then recording the user's answers to the questions in the database 32. For example, the questions or prompts may be directed to illicit information from a user regarding at least parameters 36m-o. In some embodiments, the supply chain risk mitigation system 10 may prompt a user via one or more user devices 14 illustrated in FIG. 1. In some embodiments, one or more documents and/or data (e.g., spreadsheets) may be provided to the supply chain risk mitigation system 10 for analysis and determination of the parameters 36m-o and for recording the parameters 36m-o into the database 32. In some embodiments, a third party system or external system 22, as illustrated in FIG. 1, may provide data regarding one or more parameters 36m-o. For example, one or more external systems 22 may provide data relating to the quality rating 36m for analysis by the supply chain risk mitigation system 10.

Manufacturer part data related to quality rating 36m of the manufacturer part 42 may provide two or more classifications on the quality rating 36m of the part 42 such as, for example, severe manufacturer alert, major field issue, no issue, pending validation, currently being monitored, and/or the like. In some embodiments, classifications may be grouped based on risk level. For example, a first group Q1 may indicate a severe manufacturer alert or major field issue associated with the part 42. A second group Q2 may indicate pending validation of the part 42, or the part 42 is currently being monitored. A third group Q3 may indicate there are no current issues with the quality of the part 42.

Manufacturer part data related to the capacity constraint 36n of the part 42 may also be identified. For example, capacity constraint 36n may be determined based on available quantity that a manufacturer has on hand, or in another example, the capacity constraint 36n may be based on limitations of the contract manufacturer (e.g., assembly line limitations).

The manufacturer part data may also have a technical approval status 36o identified. For example, the technical approval status 36o may identify the manufacturer part 42 as potential, approved, disqualified, end-of-life, and/or the like.

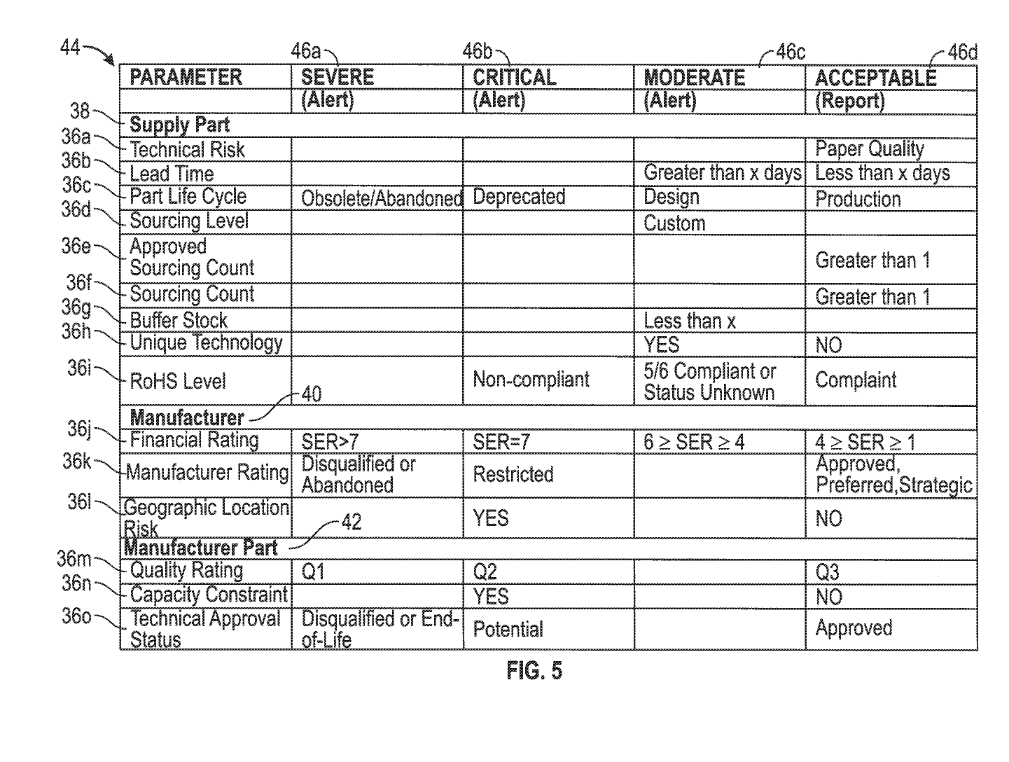

FIG. 5 illustrates an exemplary risk rating system 44 for the supply chain risk mitigation system 10. Generally, the risk rating system 44 may analyze certain for all of the parameters 36a-36o to determine a classification of a procurement risk rating 46 using product part data, manufacturer data, and manufacturer part data. Additionally, one or more alerts and/or reports may be automatically and/or manually generated providing current and past risk ratings 46.

Generally, the risk rating system 44 may include two or more composite procurement risk ratings 46. Each composite procurement risk rating 46 may be based on classification of parameters (e.g., lead time, financial stability) as compared to predetermined rule sets. The risk rating system 44, illustrated in FIG. 5, includes four distinct composite procurement risk ratings: severe 46a, critical 46b, moderate 46c, and acceptable 46d an exemplary rule sets are depicted in FIG. 5. Although four qualitative composite procurement risk ratings 46a-d are illustrated based on a calculation of the parameters against numerical rule sets, it should be understood that any number of composite procurement risk ratings 46 more than one may be used. Additionally, in some embodiments, procurement risk ratings 46 may be provided on a qualitative scale, a numerical scale (e.g., 1 to 10), in a percentage (e.g., 80% risk), and/or the like. Further, it should be noted that one or more sub-categories may be included within the procurement risk rating system 44 in that one or more of the procurement risk ratings 46 may include one or more sub-categories. For example, moderate 46c may include a sub-category moderate*, and critical may include a sub-category critical*.

In one aspect of the risk rating system 44, a single parameter (e.g., 36a-36n, or 36o) may be analyzed to generate the particular composite procurement risk rating 46a-46d. For example, if a part 38 is determined obsolete within the life cycle 36c, the procurement risk rating 46a may be deemed severe 36a without additional guidance from other parameters 36. In another example, if there is no geographic location risk 36l, the procurement risk rating 46d may be deemed acceptable without additional guidance from other parameters 36.

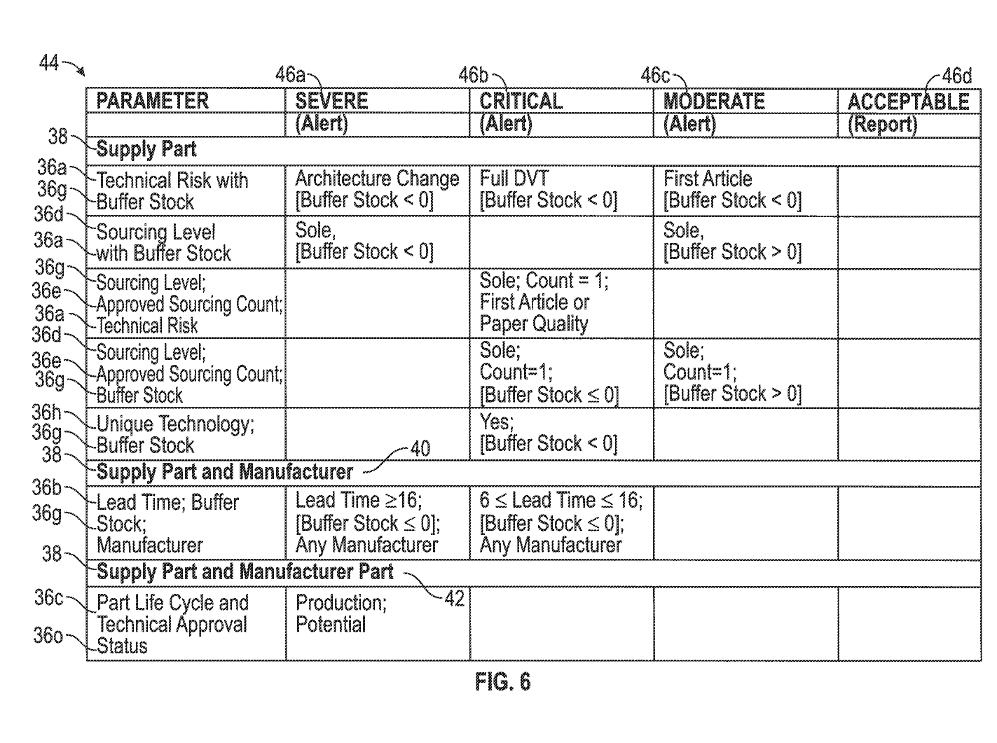

In some embodiments, multiple parameters 36 may be used to determine the procurement risk rating 46. For example, FIG. 6 illustrates several exemplary combined parameters that may be used to determine the procurement risk rating 46a-46d. Any combination of part parameters 36a-36i, manufacturer parameters 36j-l, and/or manufacturer part parameters 36m-36o may be combined. Analysis of the resulting combination may be used to determine the procurement risk rating 46a-46d. For example, technical risk 36a may be combined with buffer stock 36g such that if there is an architecture change in the product part 38 and there is no buffer stock available, the resulting procurement risk rating would be severe 46a. In a similar manner, lead time 36b of the product part 38, buffer stock 36g and the proposed or available manufacturer may be analyzed such that if the lead time is greater than 16 weeks and there is no buffer stock available, the procurement risk rating would be severe 46a with any manufacturer. FIG. 6 illustrates additional exemplary combinations, however, any combination of parameters 36a-36o are contemplated.

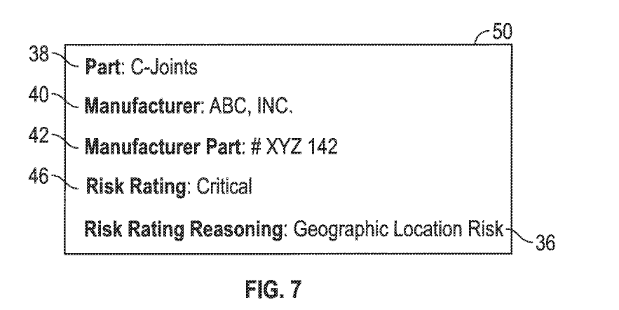

Upon determination of an initial risk rating 46a-46d, one or more alert and/or report 50 may be generated as illustrated in FIG. 7. The report 50 may provide data including, but not limited to, identification of the product part 38, manufacturer 40, the manufacturer's part, 42, the risk rating 46, and one or more parameters 36 determining the procurement risk rating 46. In some embodiments, alerts and/or reports 50 may be automatically generated and provided to a predefined set of the one or more user devices 14 as updates of the parameters 36a-36o are recorded into the database 32. In this manner, users who need to know whether or not the risk is changing with procuring particular product parts 38 are automatically informed as the database 32 is being updated.

Referring to FIGS. 1, 5 and 6, update of the parameters 36a-36o may be manual, automatic, or a combination of both. For example, one or more external systems 22 and/or one or more user devices 14 may update one or more of the parameters 36a-36o. Updates to one or more parameters 36a-36o may be on-demand or scheduled periodically. For example, a count of the available buffer stock 36g may be requested periodically (e.g., every quarter).

As information may be provided to the supply chain risk mitigation system 10 at different intervals by users entering the information into the database 32 and/or the program logic 34 polling one or more external systems 22, the procurement risk rating 46a-46d may be calculated and thereby updated for each product part 38 automatically. For example, if data is received by the supply chain risk mitigation system 10 indicating that the geographic location risk 36l of the manufacturer 40 has changed, the procurement risk rating may be automatically updated. Upon updating, one or more alerts and/or report 50 may be generated and distributed automatically. For example, as illustrated in FIGS. 1, 5 and 6, alerts may be generated and distributed by the host system 12 automatically to one or more predefined sets of user devices 14 if the procurement risk rating 46 becomes severe 46a, critical 46b, or moderate 46c. Alerts may include one or more messages providing the procurement risk rating 46. Such messages may be transmitted to the user devices 14, for example, via e-mail, telephone, text message and/or any other similar message medium. If the procurement risk rating 46 remains acceptable, one or more reports 50 may be provided to the user devices 14 on an as needed basis or on-demand. Alternatively, a user may be capable of querying the host system 12 to provide one or more procurement risk ratings 46. Such queries may be provided to the user in a report similar to report 50.

In some embodiments, an assembly report may be provided. The assembly report may include all parts in the design, production, and deprecated lifecycle of a system. The report may include one or more percentages of each procurement risk rating 46 along with the number of parts associated with the risk rating 46. For example, the assembly report may state Severe: 10% (12); Critical 20% (24), Moderate 40% (5), and Acceptable 30% (30). The assembly report may also list one or more parameters 36 and the associated data related to each parameter. Even further, any assembly, sub-assembly and/or product having prior rated parts may be provided a “net” composite risk rating 46.

Additionally, a user may query the host system 12 to provide one or more reports indicating procurement risk rating 46 and, product parts 38 that do not have an acceptable manufacturer, manufacturer parts 42 located within a particular geographic region, product parts 38 that have a particular sourcing level (e.g., SOLE), product parts 38 with a particular sourcing level, and/or the like. In some embodiments, a user may query the host system 12 to provide one or more reports indicating a time interval in which one or more parameters changed.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A method, comprising:
establishing communication between at least one host system having at least one microprocessor and at least one user device having an input device and an output device;
registering, by the host system, product part data from the user device, the product part data having at least one parameter indicative of type and need of a product part for a system;
registering, by the host system, manufacturer data from the user device, the manufacturer data having at least one parameter indicative of a business factor associated with the manufacturer capable of providing a manufacturer part for the product part;
registering, by the host system, manufacturer part data from the user device, the manufacturer part data having at least one parameter indicative of properties of the manufacturer part;
analyzing the parameters of the product part data, manufacturer data and manufacturer part data with at least one predetermined rule set to determine a composite procurement risk rating of procuring the product part; and,
automatically generating an alert and transmitting the alert to a predefined set of at least one user device, the alert including the composite procurement risk rating.

2. The method of claim 1, wherein determination of the composite procurement risk rating is based on a single parameter.

3. The method of claim 1, wherein determination of the composite procurement risk rating is based on a combination of multiple parameters.

4. The method of claim 3, wherein at least one of the parameters includes product part data.

5. The method of claim 3, wherein at least one of the parameters includes product part data and manufacturer data.

6. The method of claim 3, wherein at least one of the parameters includes product part data and manufacturer part data.

7. The method of claim 1, wherein at least one parameter associated with the product part includes an amount of buffer stock available for the product part.

8. The method of claim 1, wherein at least one parameter associated with the manufacturer includes geographic risk.

9. The method of claim 1, further comprising the step of updating at least one parameter of the product part data, manufacturer data, and manufacturer part data to provide at least one updated parameter; and, analyzing, without user intervention, the updated parameter of the product part data, manufacturer data and manufacturer part data to determine an updated composite procurement risk rating.

10. The method of claim 9, further comprising the step of generating an automatic updated report including the updated composite procurement risk rating.

11. A system, comprising:
a host system having a microprocessor; and,
a computer readable medium storing a set of instructions that when executed by the microprocessor cause the microprocessor to:
obtain and record in a database product part data indicative of at least two parameters for procuring a product part for a system;
extract and analyze the parameters in the database to determine a procurement risk rating without manual intervention and in real-time as the product part data is recorded into the database; and
generate and transmit to a user device, without manual intervention, an alert if the procurement risk rating is within a predefined category.

12. The system of claim 11, wherein the set of instructions cause the processor to obtain manufacturer data indicative of at least one parameter of a manufacturer capable of supplying a manufacturer part for the product part.

13. The system of claim 12, wherein analysis of the parameters includes analysis of at least one parameter of the product part data and at least one parameter of manufacturer data.

14. The system of claim 13, wherein at least one parameter of the manufacturer data includes geographic location risk.

15. The system of claim 16, wherein the microprocessor receives product part data to the host system from the user device.

16. The system of claim 11, wherein at least one parameter associated with the product part includes an amount of buffer stock available for the product part.

17. A system, comprising:
a host system having a microprocessor;
at least one user device communicating with the host system; and,
a computer readable medium storing a set of instructions that when executed by the host system, cause the microprocessor to:
analyze a database being dynamically updated with at least one parameter of supply chain data, manufacturer data and manufacturer part data to determine a current procurement risk rating;
comparing, without user intervention, the current procurement risk rating to a past procurement risk rating stored in the database; and,
generate and transmit a report to the user device without user intervention responsive to the current procurement risk rating being different from the past procurement risk rating.
